(19) United States
(12) Patent Application Publication
(10) Pub. No.: US 2020/0296880 A1
(43) Pub. Date: Sep. 24, 2020

(54) PLANTING AND MANAGEMENT METHOD OF GRASS-WHITE CLOVER GRASSLAND

(71) Applicant: LANZHOU UNIVERSITY, Lanzhou City (CN)

(72) Inventors: Yingwen Yu, Lanzhou City (CN); Tinghua Hu, Lanzhou City (CN); Wen Wang, Lanzhou City (CN); Zhen Xu, Lanzhou City (CN); Wenya Mao, Lanzhou City (CN)

(73) Assignee: LANZHOU UNIVERSITY, Lanzhou City (CN)

(21) Appl. No.: 16/694,046

(22) Filed: Nov. 25, 2019

(30) Foreign Application Priority Data
Mar. 18, 2019 (CN) CN201910205161.7

(51) Int. Cl. A01C 7/00; A01C 7/08; A01C 21/00

(52) U.S. Cl. CPC A01C 7/008; A01C 21/00; A01C 7/002; A01C 7/085

(57) ABSTRACT

A planting method of grass-white clover grassland includes the follows steps: (1) plowing and broadcasting Vicia villosa from July to August in a first year, applying a first base fertilizer, harvesting the Vicia villosa from December of the first year to March of a second year; (2) plowing and drilling corn from April to May of the second year, applying a second base fertilizer, weeding in a stage of 5 leaves of the corn, topdressing in a stage of 7-9 true leaves of the corn, and harvesting the corn in September of the second year; (3) plowing and drilling a grass from September to October of the second year, and applying a third base fertilizer; (4) not plowing but broadcasting white clover from May to June of a third year, applying a fourth base fertilizer, completing the planting.

### CROSS REFERENCE TO RELATED APPLICATIONS

The present application claims priority to Chinese Patent Application No. CN201910205161.7. The Chinese application is incorporated herein by reference, in entirety.

### TECHNICAL FIELD

The present invention belongs to the technical field of agricultural planting, and particularly relates to a planting and management method of grass-white clover grassland.

### BACKGROUND

Grass-white clover grassland is a major type of mixed grassland in a temperate region in the world. It has been widely planted in a karst region of southern China since the 1980s. It is major grazing grassland and mowing grassland in the karst region of southern China, and plays an important role in the local area's development of grassland animal husbandry and ecological environment protection.

At present, the improvement of grass-white clover grassland and the planting of artificial grassland in the karst region of southern China generally adopt a direct plowing and sowing method and occasionally a livestock camping method. The direct sowing method is a method of soil preparation and plowing, sowing, fertilization, and grassland grazing and mowing; the livestock camping method is to concentrate a certain number of livestock in a campsite for several nights, and after a turf of degraded grassland is completely destroyed by the trampling of the livestock and the deposition of feces and urine, sow a certain proportion of grass and white clover seeds to construct mixed grassland. Although the direct plowing and sowing method is fast, the soil structure and fertility are not fully improved during planting, and as a result, the grass-white clover grassland has many weeds and poor stability and is easy to degrade; the livestock camping method has a good planting effect, but it has the disadvantages of slow planting and high cost. At the same time, after planting, the grass-white clover grassland in southern China has the common defects of easy degradation and poor stability.

Therefore, it is extremely important to explore a method for planting and managing grass-white clover grassland with a good planting effect, a low cost and a high stability.

### SUMMARY

An objective of the present invention is to explore a planting method of grass-white clover grassland with a good planting effect and a strong stability, to provide a practical basis for the sustainable development of grassland animal husbandry in China.

The present invention provides a planting method of grass-white clover grassland, including the follows steps:

(1) plowing and broadcasting Vicia villosa from July to August in a first year, applying a first base fertilizer, and harvesting the Vicia villosa from December of the first year to March of a second year;

(2) plowing and drilling corn from April to May of the second year, applying a second base fertilizer, weeding in a stage of 5 leaves of the corn, topdressing in a stage of 7-9 true leaves of the corn, and harvesting the corn in September of the second year;

(3) plowing and drilling a grass from September to October of the second year, and applying a third base fertilizer; and

(4) not plowing but broadcasting white clover from May to June of a third year, applying a fourth base fertilizer, and completing the planting.

Preferably, in the step (3), the depth of the plowing is 20 cm.

Preferably, in the step (3), the grass is perennial ryegrass and cocksfoot; the drilling amount of the perennial ryegrass is 7-8 kg/hm²; and the drilling amount of the cocksfoot is 12-18 kg/hm². Preferably, in the step (4), after the broadcasting, the white clover is grazed and trampled by livestock, so that a white clover seed falls into the ground to contact the soil, which is favorable for seed germination.

Preferably, the first base fertilizer includes 225-300 kg/hm² of GaMgP fertilizer, 30-45 kg/hm² of K₂SO₄ fertilizer and 75-90 kg/hm² of urea; the second base fertilizer includes 225-300 kg/hm² of compound fertilizer; the third base fertilizer includes 225-300 kg/hm² of GaMgP fertilizer, 30-45 kg/hm² of K₂SO₄ fertilizer and 75-90 kg/hm² of urea; the fourth base fertilizer includes 225-300 kg/hm² of GaMgP fertilizer, 30-45 kg/hm² of K₂SO₄ fertilizer and 75-90 kg/hm² of urea; in the step (2), the topdressing includes 400-500 kg/hm² of urea.

Preferably, the planting method is applicable for an area in a southern karst region.

Preferably, the planting method is applicable for such type of land as grassy hill, grassy slope or seriously degraded grass-white clover grassland. The present invention provides grass-white clover grassland planted by using the above method.

The present invention further provides a management method for the above grass-white clover grassland, which is carried out from a year when planting is completed.

Preferably, the management method includes the following steps:

(1) harvesting herbage by mowing from the end of July to the beginning of August, remaining a stubble height of 6-10 cm;

(2) carrying out rotational grazing 2-3 times before November, where the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;

(3) carrying out rotational grazing 3-5 times from November to May of a second year, where the duration of the rotational grazing is 5-7 days each time, and the height of the herbage layer is 2-5 cm after grazing;

(4) topdressing with 225-300 kg/hm² of GaMgP fertilizer, 30-45 kg/hm² of K₂SO₄ fertilizer, and 75-90 kg/hm² of urea in a rainy season from the end of May to the beginning of June of the second year;

(5) harvesting herbage by mowing from June to July of the second year, remaining a stubble height of 6-10 cm;

(6) carrying out rotational grazing 3-4 times before November of the second year, where the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing; and

(7) carrying out rotational grazing 3-5 times from November of the second year to May of a third year, where the duration of the rotational grazing is 5-7 days each time, and the height of the herbage layer is 2-5 cm after grazing; and

repeating the above steps in the order of (4), (5), (6) and (7).

As another preferable aspect, a management method includes the following steps:

I. harvesting herbage by mowing from the end of July to the beginning of August, remaining a stubble height of 6-10 cm;

II. carrying out rotational grazing 2-3 times before November, where the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;

III. carrying out rotational grazing 3-5 times from November to May of a second year, where the duration of the rotational grazing is 5-7 days each time, and the height of the herbage layer is 2-5 cm after grazing;

IV. topdressing with 225-300 kg/hm² of GaMgP fertilizer, 30-45 kg/hm² of K₂SO₄ fertilizer, and 75-90 kg/hm² of urea in a rainy season from the end of May to the beginning of June of the second year;

V. harvesting herbage by mowing from June to July of the second year, remaining a stubble height of 6-10 cm;

VI. harvesting herbage by mowing in August of the second year when the herbage layer grows to 40-60 cm in height, remaining a stubble height of 6-10 cm;

VII. resowing Vicia villosa by broadcasting, and topdressing with a first base fertilizer;

VIII. harvesting regrown herbage by mowing in November of the second year, remaining a stubble height of 6-10 cm; and

IX. carrying out rotational grazing 3-5 times from November of the second year to May of a third year, where the duration of the rotational grazing is 5-7 days each time, and the height of the herbage layer is 2-5 cm after grazing;

repeating the above steps in the order of IV, V, VI, VII, VIII and IX.

Beneficial Effects: The present invention provides a planting method of grass-white clover grassland, including the follows steps: (1) plowing and broadcasting Vicia villosa from July to August in a first year, applying a first base fertilizer, and harvesting the Vicia villosa from December of the first year to March of a second year; (2) plowing and drilling corn from April to May of the second year, applying a second base fertilizer, weeding in a stage of 5 leaves of the corn, topdressing in a stage of 7-9 true leaves of the corn, and harvesting the corn in September of the second year; (3) plowing and drilling a grass from September to October of the second year, and applying a third base fertilizer; and (4) not plowing but broadcasting white clover from May to June of a third year, applying a fourth base fertilizer, and completing the planting. The planting method provided by the present invention can be managed by mechanized operation throughout the whole process, the proportion of a weed in the planted grassland is generally less than 20%, and the planting method has a broad application prospect.

The present invention provides grass-white clover grassland planted by using the above planting method. The present invention further provides two management methods of the above grass-white clover grassland, and by managing the planted grassland by the management methods provided by the present invention, the stability of the grass-white clover grassland can be maintained for a long time, and the grassland has few weeds and is not easy to degrade.

### BRIEF DESCRIPTION OF THE DRAWINGS

FIG. 1 is a comparison result of soil organic matter and herbage N contents of a planting method and a conventional planting method according to Embodiment 1 of the present invention;

FIG. 2 is a diagram showing aboveground biomass composition of a planting method and a conventional planting method according to Embodiment 1 of the present invention;

FIG. 3 is a comparison result of soil organic matter and herbage N contents of a planting method and a conventional planting method according to Embodiment 2 of the present invention; and

FIG. 4 is a diagram showing aboveground biomass composition of a planting method and a conventional planting method according to Embodiment 2 of the present invention.

### DETAILED DESCRIPTION

The present invention provides a planting method of grass-white clover grassland, including the follows steps:

(1) plow and broadcast Vicia villosa from July to August in a first year, apply a first base fertilizer, and harvest the Vicia villosa from December of the first year to March of a second year;

(2) plow and drill corn from April to May of the second year, apply a second base fertilizer, weed in a stage of 5 leaves of the corn, topdress in a stage of 7-9 true leaves of the corn, and harvest the corn in September of the second year;

(3) plow and drill a grass from September to October of the second year, and apply a third base fertilizer; and

(4) not plow but broadcast white clover from May to June of a third year, apply a fourth base fertilizer, and complete the planting.

The present invention firstly plows and broadcasts the Vicia villosa in the first year. In the present invention, the land for broadcasting the Vicia villosa is preferably located in a southern karst region. The type of the land for broadcasting the Vicia villosa is preferably grassy hill, grassy slope or seriously degraded grass-white clover grassland, and more preferably, heavily degraded grass-white clover grassland. The present invention plows before broadcasting, and the plowing has the characteristic of rapidly improving a soil structure. The broadcasting follows the plowing, and the time of the broadcasting is preferably from July to August of the first year, and more preferably at the beginning of August of the first year. In the present invention, the broadcasting amount of a Vicia villosa seed is preferably 90-120 kg/hm², and more preferably 100-110 kg/hm². The Vicia villosa seed is preferably selected according to the following quality requirement: 100% purity and 100% germination rate; if the standard is not reached, the broadcasting amount is converted proportionally (for example, for a seed having 80% purity and 80% germination rate, its broadcasting amount is (100÷80)×(100÷80)=1.5625 times as much as the standard seeds).The present invention preferably applies the first base fertilizer while broadcasting. The first base fertilizer preferably includes a GaMgP fertilizer, a K₂SO₄.fertilizer and urea; the application rate of the GaMgP fertilizer is preferably 225-300 kg/hm², more preferably 250-275 kg/hm²; the application rate of the K₂SO₄.fertilizer is preferably 30-45 kg/hm², more preferably 35-40 kg/hm²; the application rate of the urea is preferably 75-90 kg/hm², more preferably 80-85 kg/hm². The present invention has no special limit on the source of each raw material of the base fertilizer above, and a conventional, commercially available product in the art can be used. In an embodiment of the present invention, the GaMgP fertilizer is purchased from Yunnan Kunyang Phosphorus Capital Calcium Magnesium Phosphate Fertilizer Plant, and the specifications are in accordance with GB20412-2006 and XK13-002-00623 (available P₂O₅≥18.0%); the K₂SO₄ fertilizer is purchased from Qinghai CITIC Guoan Lithium Development Co., Ltd., and the specifications are in accordance with GB/T20406-2006 (K₂O≥51.0%, CI⁻≤1.5%); the urea is purchased from Yunnan Yuntianhua Co., Ltd., and the specifications are in accordance with GB2440-2001 (N content ≥46.4%). The Vicia villosa is harvested from December of the first year to March of the second year. The manner of the harvesting is preferably mechanical mowing; the mechanical mowing is preferably carried out twice, the time of the first mowing is preferably December of the first year, and the time of the second mowing is preferably the beginning of March of the second year.

The present invention plows and drills a corn seed from April to May of the second year. The present invention preferably plows before drilling, and the time of the plowing is preferably late April of the second year; the drilling follows the plowing and soil preparation, and the time of the drilling is preferably the beginning of May of the second year. In the present invention, the broadcasting amount of the corn seed is preferably 40-50 kg/hm², and more preferably 45 kg/hm². The present invention has no special limit on the source of the corn seed, and a conventional, commercially available forage corn seed in the art can be used. Forage corn has a longer green period than grain corn, a high yield as herbage, good quality, and good palatability for livestock, and can provide high-quality herbage for the development of grassland animal husbandry. In an embodiment of the present invention, the variety of the corn seed is “Huibaiyu No. 11”. The present invention preferably applies the second base fertilizer while drilling the corn seed. The second base fertilizer is preferably a compound fertilizer, and the application rate of the compound fertilizer is preferably 225-300 kg/hm², more preferably 250-275 kg/hm². The present invention has no special limit on the source of the compound fertilizer, and a conventional, commercially available product in the art can be used. In an embodiment of the present invention, total nutrients of the compound fertilizer is ≥45% (N—P₂O₅—K₂O), and the compound fertilizer is preferably purchased from Yunnan Yuntianhua Co., Ltd. The present invention weeds in a stage of 5 leaves of the corn after the corn is sown. The weeding preferably uses an herbicide, and the herbicide is a conventional, commercially available, and eligible product in the art. The present invention topdresses in a stage of 7-9 true leaves of the corn; the topdressing is preferably topdressing of a nitrogen fertilizer; the nitrogen fertilizer is preferably urea (including 46.4% of N), and the application rate of the urea is preferably 400-500 kg/hm², more preferably 450 kg/hm². The present invention harvests the corn in September of the second year, and the manner of the harvesting is preferably mechanical mowing. The corn harvested by mowing is preferably made into silage.

After harvesting the corn, the present invention plows and drills a grass. In the present invention, the drilling time of the grass is preferably from September to October of the second year, and more preferably from the end of September to the beginning of October of the second year. The present invention preferably plows before the drilling; in this step, the depth of the plowing is preferably 20 cm, thereby sufficiently improving the soil structure of the previous corn. In the present invention, the variety of the grass is preferably perennial ryegrass and cocksfoot; the drilling amount of the perennial ryegrass is preferably 7-8 kg/hm², more preferably 7.5 kg/hm²; the drilling amount of the cocksfoot is preferably 12-18 kg/hm², more preferably 15 kg/hm². The perennial ryegrass and the cocksfoot are preferably mixed for sowing, and the row spacing of the mixed sowing is preferably 10-18 cm, more preferably 13-15 cm. The drilling depth of the grass is preferably 2-5 cm, more preferably 3 cm, and covering soil after the drilling is preferably 2-3 cm. The present invention preferably applies the third base fertilizer while drilling. The third base fertilizer preferably includes a GaMgP fertilizer, a K₂SO₄ fertilizer and urea; the application rate of the GaMgP fertilizer is preferably 225-300 kg/hm², more preferably 250-275 kg/hm²; the application rate of the K₂SO₄ fertilizer is preferably 30-45 kg/hm², more preferably 35-40 kg/hm²; the application rate of the urea is preferably 75-90 kg/hm², more preferably 80-85 kg/hm². The present invention has no special limit on the source of each raw material of the base fertilizer above, and a conventional, commercially available product in the art can be used. In an embodiment of the present invention, the GaMgP fertilizer is purchased from Yunnan Kunyang Phosphorus Capital Calcium Magnesium Phosphate Fertilizer Plant, and the specifications are in accordance with GB20412-2006 and XK13-002-00623 (available P₂O₅≥18.0%); the K₂SO₄ fertilizer is purchased from Qinghai CITIC Guoan Lithium Development Co., Ltd., and the specifications are in accordance with GB/T20406-2006 (K₂O≥51.0%, CI⁻≤1.5%); the urea is purchased from Yunnan Yuntianhua Co., Ltd., and the specifications are in accordance with GB2440-2001, with an N content ≥46.4%.

The present invention broadcasts the white clover in the third year. The time of the broadcasting is preferably from May to June of the third year, more preferably from the end of May to the beginning of June of the third year. The present invention does not plow before broadcasting the white clover, but directly broadcasts in a gap between the grasses.

The broadcasting amount is preferably 7-8 kg/hm², more preferably 7.5 kg/hm². The present invention has no special limit on the source of a white clover seed, and a conventional, commercially available product in the art can be used. The present invention preferably applies the fourth base fertilizer while broadcasting. The fourth base fertilizer preferably includes a GaMgP fertilizer, a K₂SO₄ fertilizer and urea; the application rate of the GaMgP fertilizer is preferably 225-300 kg/hm², more preferably 250-275 kg/hm²; the application rate of the K₂SO₄ fertilizer is preferably 30-45 kg/hm², more preferably 35-40 kg/hm²; the application rate of the urea is preferably 75-90 kg/hm², more preferably 80-85 kg/hm². The present invention has no special limit on the source of each raw material of the base fertilizer above, and a conventional, commercially available product in the art can be used. In an embodiment of the present invention, the GaMgP fertilizer is purchased from Yunnan Kunyang Phosphorus Capital Calcium Magnesium Phosphate Fertilizer Plant, and the specifications are in accordance with GB20412-2006 and XK13-002-00623 (available P₂O₅≥18.0%); the K₂SO₄ fertilizer is purchased from Qinghai CITIC Guoan Lithium Development Co., Ltd., and the specifications are in accordance with GB/T20406-2006 (K₂O≥51.0%, CI⁻≤1.5%); the urea is purchased from Yunnan Yuntianhua Co., Ltd., and the specifications are in accordance with GB2440-2001, with an N content ≥46.4%. After the broadcasting of white clover seeds, livestock grazes and tramples, so that the white clover seed falls into the ground to contact the soil, which is favorable for seed germination.

The present invention further provides a management method for the above grass-white clover grassland, which is carried out from a year when planting is completed. The present invention provides two management methods which are matched with the planting method, namely, a management method 1 and a management method 2.

The management method 1 includes the following steps:

(1) harvest herbage by mowing from the end of July to the beginning of August, remaining a stubble height of 6-10 cm;

(2) carry out rotational grazing 2-3 times before November, where the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;

(3) carry out rotational grazing 3-5 times from November to May of a second year, where the duration of the rotational grazing is 5-7 days each time, and the height of the herbage layer is 2-5 cm after grazing;

(4) topdress with 225-300 kg/hm² of GaMgP fertilizer, 30-45 kg/hm² of K₂SO₄ fertilizer, and 75-90 kg/hm² of urea in a rainy season from the end of May to the beginning of June of the second year;

(5) harvest herbage by mowing from June to July of the second year, remaining a stubble height of 6-10 cm;

(6) carry out rotational grazing 3-4 times before November of the second year, where the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing; and

(7) carry out rotational grazing 3-5 times from November of the second year to May of a third year, where the duration of the rotational grazing is 5-7 days each time, and the height of the herbage layer is 2-5 cm after grazing; and

repeat the above steps in the order of (4), (5), (6) and (7).

The present invention firstly harvests the herbage by mowing from the end of July to the beginning of August, during which the herbage layer is high, and the white clover just begins to germinate. Harvesting the herbage by mowing at this time is beneficial to light the white clover and promote the growth of the white clover. The stubble remained by harvesting the herbage by mowing is preferably 6-10 cm, more preferably 7-8 cm. The mowed herbage is preferably wrapped as silage.

When the herbage layer grows to 20-25 cm in height after mowing, the present invention carries out high-intensity rotational grazing of livestock. The time of the high-intensity rotational grazing of livestock is preferably 7-10 days, the intensity of the rotational grazing is preferably 50-60 sheep/hm², and the height of the herbage layer after the rotational grazing is preferably 4-8 cm, more preferably 5-6 cm. The present invention carries out about 2-3 times of rotational grazing in accordance with the above method before November.

From November to May of the second year, the present invention performs general rotational grazing according to the stock and growth of the grassland. The time of the general rotational grazing is preferably 5-7 days, and the height of the herbage layer after grazing is preferably 2-5 cm, more preferably 3-4 cm. During this time, the present invention carries out about 3-5 times of rotational grazing in accordance with the above method.

In the rainy season from the end of May to the beginning of June of the second year, the present invention topdresses with a maintenance fertilizer. The maintenance fertilizer preferably includes a GaMgP fertilizer, a K₂SO₄ fertilizer and urea; the application rate of the GaMgP fertilizer is preferably 225-300 kg/hm², more preferably 250-275 kg/hm²; the application rate of the K₂SO₄ fertilizer is preferably 30-45 kg/hm², more preferably 35-40 kg/hm²; the application rate of the urea is preferably 75-90 kg/hm², more preferably 80-85 kg/hm². The present invention has no special limit on the source of each raw material of the base fertilizer above, and a conventional, commercially available product in the art can be used. In an embodiment of the present invention, the GaMgP fertilizer is purchased from Yunnan Kunyang Phosphorus Capital Calcium Magnesium Phosphate Fertilizer Plant, and the specifications are in accordance with GB20412-2006 and XK13-002-00623 (available P₂O₅≥18.0%); the K₂SO₄ fertilizer is purchased from Qinghai CITIC Guoan Lithium Development Co., Ltd., and the specifications are in accordance with GB/T20406-2006 (K₂O≥51.0%, CI⁻≤1.5%); the urea is purchased from Yunnan Yuntianhua Co., Ltd., and the specifications are in accordance with GB2440-2001, with an N content ≥46.4%.

After the topdressing of the maintenance fertilizer, the present invention harvests the herbage by mowing from June to July of the second year. The stubble remained by harvesting the herbage by mowing is preferably 6-10 cm, more preferably 7-8 cm.

When the herbage layer grows to 20-25 cm in height after mowing, the present invention carries out high-intensity rotational grazing of livestock. The time of the high-intensity rotational grazing of livestock is preferably 7-10 days, the intensity of the rotational grazing is preferably 50-60 sheep/hm², and the height of the herbage layer after the rotational grazing is preferably 4-8 cm, more preferably 5-6 cm. The present invention carries out about 3-4 times of rotational grazing in accordance with the above method before November of the second year.

From November of the second year to May of the third year, the present invention performs general rotational grazing according to the stock and growth of the grassland. The time of the general rotational grazing is preferably 5-7 days, and the height of the herbage layer after grazing is preferably 2-5 cm, more preferably 3-4 cm. During this time, the present invention carries out about 3-5 times of rotational grazing in accordance with the above method.

The management steps are repeated in a one-year cycle from the end of May of the second year to May of the third year.

The management method 2 includes the following steps:

I. harvest herbage by mowing from the end of July to the beginning of August, remaining a stubble height of 6-10 cm;

II. carry out rotational grazing 2-3 times before November, where the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;

III. carry out rotational grazing 3-5 times from November to May of a second year, where the duration of the rotational grazing is 5-7 days each time, and the height of the herbage layer is 2-5 cm after grazing;

IV. topdress with 225-300 kg/hm² of GaMgP fertilizer, 30-45 kg/hm² of K₂SO₄ fertilizer, and 75-90 kg/hm² of urea in a rainy season from the end of May to the beginning of June of the second year;

V. harvest herbage by mowing from June to July of the second year, remaining a stubble height of 6-10 cm;

VI. harvest herbage by mowing in August of the second year when a herbage layer grows to 40-60 cm in height, remaining a stubble height of 6-10 cm;

VII. resow Vicia villosa by broadcasting, and topdress with a first base fertilizer;

VIII. harvest regrown herbage by mowing in November of the second year, remaining a stubble height of 6-10 cm; and

IX. carry out rotational grazing 3-5 times from November of the second year to May of a third year, where the duration of the rotational grazing is 5-7 days each time, and the height of the herbage layer is 2-5 cm after grazing;

repeat the above steps in the order of IV, V, VI, VII, VIII and IX.

The present invention firstly harvests the herbage by mowing from the end of July to the beginning of August, during which the herbage layer is high, and the white clover just begins to germinate. Harvesting the herbage by mowing at this time is beneficial to light the white clover and promote the growth of the white clover. The stubble remained by harvesting the herbage by mowing is preferably 6-10 cm, more preferably 7-8 cm. The mowed herbage is preferably wrapped as silage.

When the herbage layer grows to 20-25 cm in height after mowing, the present invention carries out high-intensity rotational grazing of livestock. The time of the high-intensity rotational grazing of livestock is preferably 7-10 days, the intensity of the rotational grazing is preferably 50-60 sheep/hm², and the height of the herbage layer after the rotational grazing is preferably 4-8 cm, more preferably 5-6 cm. The present invention carries out about 2-3 times of rotational grazing in accordance with the above method before November.

From November to May of the second year, the present invention performs general rotational grazing according to the herbage biomass and growth of the grassland. The time of the general rotational grazing is preferably 5-7 days, and the height of the herbage layer after grazing is preferably 2-5 cm, more preferably 3-4 cm. During this time, the present invention carries out about 3-5 times of rotational grazing in accordance with the above method.

In the rainy season from the end of May to the beginning of June of the second year, the present invention topdresses with a maintenance fertilizer. The maintenance fertilizer preferably includes a GaMgP fertilizer, a K₂SO₄ fertilizer and urea; the application rate of the GaMgP fertilizer is preferably 225-300 kg/hm², more preferably 250-275 kg/hm²; the application rate of the K₂SO₄ fertilizer is preferably 30-45 kg/hm², more preferably 35-40 kg/hm²; the application rate of the urea is preferably 75-90 kg/hm², more preferably 80-85 kg/hm². The present invention has no special limit on the source of each raw material of the base fertilizer above, and a conventional, commercially available product in the art can be used. In an embodiment of the present invention, the GaMgP fertilizer is purchased from Yunnan Kunyang Phosphorus Capital Calcium Magnesium Phosphate Fertilizer Plant, and the specifications are in accordance with GB20412-2006 and XK13-002-00623 (available P₂O₅≥18.0%); the K₂SO₄ fertilizer is purchased from Qinghai CITIC Guoan Lithium Development Co., Ltd., and the specifications are in accordance with GB/T20406-2006 (K₂O≥51.0%, CI⁻≤1.5%); the urea is purchased from Yunnan Yuntianhua Co., Ltd., and the specifications are in accordance with GB2440-2001, with an N content ≥46.4%.

After the topdressing of the maintenance fertilizer, the present invention harvests the herbage by mowing from June to July of the second year. The stubble remained by harvesting the herbages by mowing is preferably 6-10 cm, more preferably 7-8 cm.

The present invention carries out a second round of mowing on the herbage in August of the second year. The height of the herbage layer in the second round of mowing is preferably 40-60 cm, more preferably 45-55 cm. The stubble remained by harvesting the herbage by the second round of mowing is preferably 6-10 cm, more preferably 7-8 cm.

After the second round of mowing, the present invention resows the Vicia villosa by broadcasting. In the present invention, the broadcasting amount of a Vicia villosa seed is preferably 90-120 kg/hm², and more preferably 100-110 kg/hm². The present invention topdresses with the first base fertilizer while broadcasting.

After the resowing of the Vicia villosa, a third round of mowing is carried out in November of the second year. The height of the herbage layer in the third round of mowing is preferably 40-60 cm, more preferably 45-55 cm. The stubble remained by harvesting the herbage by the third round of mowing is preferably 6-10 cm, more preferably 7-8 cm.

From November of the second year to May of the third year, the present invention performs general rotational grazing according to the herbage biomass and growth of the grassland. The time of the general rotational grazing is preferably 5-7 days, and the height of the herbage layer after grazing is preferably 2-5 cm, more preferably 3-4 cm. During this time, the present invention carries out about 3-5 times of rotational grazing in accordance with the above method.

The management steps are repeated in a one-year cycle from the end of May of the second year to May of the third year.

The following describes the planting and management method of grass-white clover grassland provided by the present invention in detail with reference to embodiments, but the embodiments may not be construed as a limitation to the protection scope of the present invention.

### Embodiment 1

(1) Overview of Study Area

The study area is located in Tianshengqiao Area, Zhongyangchang, Beidaying, Xundian County, Yunnan Province. Its geographical coordinates are E103° 13′ 38′′, N25° 36′ 35′′, and altitude is 2,084 m. It has subtropical climate with an average annual temperature of 13.4° C., a maximum of 18.5° C. in July, and a minimum of 6.2° C. in January. The area has rainfall and high temperature during the same period. The annual precipitation is 965.1 mm, and the rainy season is from May to October, with the precipitation of 872.8 mm, accounting for 90.4% of the annual precipitation. The mean annual sunshine duration is 1,900-2,200 h, the relative sunshine duration is 45%-52%, and the soil type is red loam.

(2) Selection of Sample Plot

In mid-July 2014, grass-white clover grassland that had been mowed and grazed for many years and had been seriously degraded in this area was selected as a to-be-replanted sample plot. An aboveground biomass composition of cocksfoot and perennial ryegrass on the degraded grassland sample plot was ≤20.7%, and an aboveground biomass composition of white clover was ≤2.0%.

(3) Planting of Grass-White Clover Grassland

The grassland planting steps are as follows.

A first step was to plow and broadcast Vicia villosa. At the beginning of August 2014, after mechanical plowing, 100 kg/hm² of Vicia villosa was broadcast by a fertilizer distributer, and at the same time, 250 kg/hm² of GaMgP fertilizer, 40 kg/hm² of K₂SO₄ fertilizer and 80 kg/hm² of urea (including 46.4% of N) were applied as a first base fertilizer by the fertilizer distributer. At the beginning of December 2014 and at the beginning of March of the following year, the herbage was respectively harvested by mechanical mowing to make green hay.

A second step was to plow and drill corn. In late April 2015, the grassland where the Vicia villosa was planted at the beginning of August 2014 and the green hay harvested was plowed and compacted. At the beginning of May 2015, 45 kg/hm² of Huibaiyu No. 11 forage corn was drilled by a drill, and at the same time, 250 kg/hm² of compound fertilizer was applied as a second base fertilizer by the corn sower. In a stage of 5 leaves of the corn, a weed was removed, and in a stage of 7-9 true leaves of the corn, 450 kg/hm² of urea was applied by the fertilizer distributer (including 46.4% of N). In mid-September 2015, the corn was harvested by mechanical mowing to make silage.

A third step was to plow and drill a grass. After the corn was harvested, the soil was mechanically plowed for 20 cm and leveled. At the beginning of October 2015, perennial ryegrass (7.5 kg/hm²)+cocksfoot (15.0 kg/hm²) seeds were drilled by a grass sower, with a row spacing of 13-15 cm, a sowing depth of 3.0 cm, and covering soil of 2-3 cm; at the same time, 250 kg/hm² of GaMgP fertilizer, 40 kg/hm² of K₂SO₄ fertilizer and 80 kg/hm² of urea (including 46.4% of N) were applied as a third base fertilizer by the grass sower.

A fourth step was not to plow but directly broadcast white clover, and complete the planting of the grass-white clover grassland. At the end of May 2016, 7.5 kg/hm² of white clover seeds were broadcast by a fertilizer distributer. After the sowing, livestock properly grazed and trampled, so that the white clover seeds fell into the ground to contact the soil, which was favorable for seed germination; at the same time, 250 kg/hm² of GaMgP fertilizer, 40 kg/hm² of K₂SO₄ fertilizer and 80 kg/hm² of urea (including 46.4% of N) were applied as a fourth base fertilizer by the fertilizer distributer.

(4) Management of Grass-White Clover Grassland

At the end of July 2016, herbage was firstly harvested by mechanical mowing and wrapped as silage, and a stubble of 7-8 cm was remained.

Then, when after herbage was as high as 20-25 cm, rotational grazing of sheep was carried out for 8 days, with an intensity of 55 sheep/hm²; the height of a herbage layer was 5-6 cm after grazing, and the rotational grazing was carried out 2 times till the beginning of November.

From mid-November 2016 to the beginning of May 2017, each time when the after herbage grew to about 20 cm, rotational grazing of sheep was carried out for 6 days; the height of the herbage layer was 3-4 cm after grazing, and the rotational grazing was carried out 3 times in total.

At the beginning of June 2017, 250 kg/hm² of GaMgP fertilizer, 40 kg/hm² of K₂SO₄ fertilizer and 80 kg/hm² of urea (including 46.4% of N) were applied as a topdressing by the fertilizer distributer.

When herbage was growing vigorously (at the beginning of July 2017), it was harvested by mechanical mowing and wrapped as silage, and a stubble height of 7-8 cm was remained. Then, when after herbage was as high as 20-25 cm, rotational grazing of sheep was carried out for 8 days, with an intensity of 55 sheep/hm²; the rotational grazing was carried out 3 times till the beginning of November.

From mid-November to the beginning of May 2018, when the after herbage grew to about 20 cm, rotational grazing of sheep was carried out for 6 days; the height of the herbage layer was 3-4 cm after grazing, and the rotational grazing was carried out 4 times.

(5) Comparison of Soil and Herbage Characteristics of Grass-White Clover Grassland Planted by Using the Method of the Present Invention and that Planted by Using a Conventional Planting Method

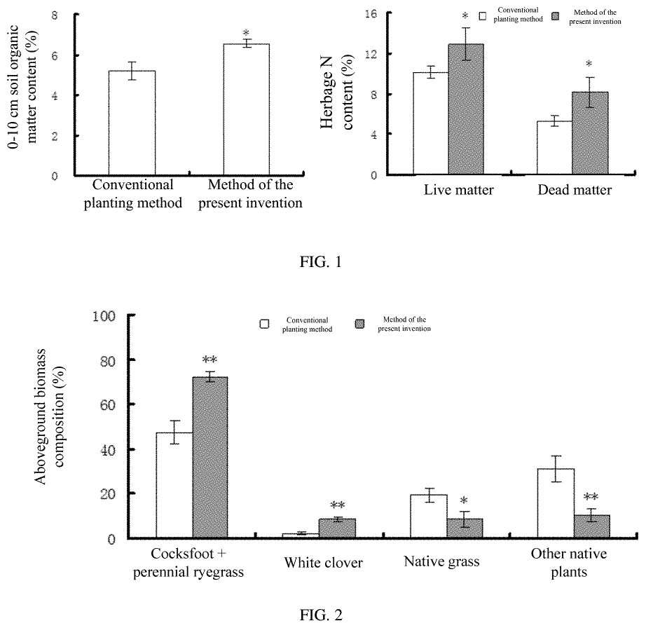

At the beginning of August 2018, a 0-10 cm soil organic matter content, aboveground group biomass composition (sown grass (cocksfoot+perennial ryegrass), white clover, native grass, other native plants) and N contents of aboveground dead and live matters of the grass-white clover grassland planted by using the method of the present invention and that planted by using the conventional planting method (direct plowing and sowing method) were determined, and the results are shown in FIG. 1 and FIG. 2. The results of FIG. 1 show that the soil organic matter content and the N content of the herbage in the grass-white clover grassland planted by using the method of the present invention are higher than those of the conventional planting method; the results of FIG. 2 show that the herbage varieties sown in the grass-white clover grassland planted by using the method of the present invention have a higher aboveground biomass composition than that of the conventional planting method.

### Embodiment 2

(1) Overview of Study Area

The study area is located in Zhangsuo Area, Zhongyangchang, Beidaying, Xundian County, Yunnan Province. Its geographical coordinates are E103° 14′ 09′ ′, N25° 36′ 15′ ′, and altitude is 1,970 m. It has subtropical climate with an average annual temperature of 13.4° C., a maximum of 18.6° C. in July, and a minimum of 6.2° C. in January. The area has rainfall and high temperature during the same period. The annual precipitation is 965.1 mm, and the rainy season is from May to October, with the precipitation of 872.8 mm, accounting for 90.4% of the annual precipitation. The mean annual sunshine duration is 2,100 h, the relative sunshine duration is 48%, and the soil type is red loam.

(2) Selection of Sample Plot

In mid-June 2012, grass-white clover grassland that had been mowed and grazed for many years and had been seriously degraded in this area was selected as a to-be-replanted sample plot. An aboveground biomass composition of cocksfoot and perennial ryegrass on the degraded grassland sample plot was ≤22%, and an aboveground biomass composition of white clover was ≤2%.

(3) Planting of Grass-White Clover Grassland

The grassland planting steps are as follows.

A first step was to plow and broadcast Vicia villosa. At the end of July 2012, the land was plowed, and 100 kg/hm² of Vicia villosa was broadcast; a first base fertilizer was applied, and the type and fertilization amount of the fertilizer were 250 kg/hm² of GaMgP fertilizer, 40 kg/hm² of K₂SO₄ fertilizer and 80 kg/hm² of urea (including 46.4% of N). At the beginning of December 2012 and mid-March 2013, herbage was harvested by mowing to make green hay.

A second step was to plow and drill corn. In late April 2013, the land was plowed, and 45 kg/hm² of Huibaiyu No. 11 forage corn was drilled; a second base fertilizer was applied, and the type and fertilization amount of the fertilizer were 250 kg/hm² of compound fertilizer. In a stage of 5 leaves of the corn, a weed was removed, and in a stage of 7-9 true leaves of the corn, 450 kg/hm² of urea (including 46.4% of N) was topdressed. The corn was harvested in mid-September 2013.

A third step was to plow and drill a grass. At the beginning of October 2013, the land where the corn was harvested was plowed and leveled, and then 7.5 kg/hm² of perennial ryegrass seeds and 15.0 kg/hm² of cocksfoot seeds were drilled, with a row spacing of 13-15 cm, a sowing depth of 3.0 cm, and covering soil of 2-3cm; a third base fertilizer was applied, and the type and fertilization amount of the fertilizer were 250 kg/hm² of GaMgP fertilizer, 40 kg/hm² of K₂SO₄ fertilizer and 80 kg/hm² of urea (including 46.4% of N).

A fourth step was not to plow but broadcast white clover, and complete the planting of the grass-white clover grassland. At the end of May 2014, 7.5 kg/hm² of white clover seeds were broadcast; a fourth base fertilizer was applied, and the type and fertilization amount of the fertilizer were 250 kg/hm² of GaMgP fertilizer, 40 kg/hm² of K₂SO₄ fertilizer, and 80 kg/hm² of urea (including 46.4% of N).

(4) Management of Grass-White Clover Grassland

At the end of July 2014, herbage was harvested by mowing, and a stubble height of 7-8 cm was remained. When after herbage was as high as 20-25 cm, rotational grazing of sheep was carried out for 10 days, with an intensity of 60 sheep/hm²; the height of a herbage layer was 5-6 cm after grazing, and the rotational grazing was carried out 2 times till the beginning of November. From mid-November 2014 to the beginning of May 2015, when the after herbage grew to 20-22 cm, rotational grazing of sheep was carried out for 7 days; the height of the herbage layer was 3-4 cm after grazing, and the rotational grazing was carried out 3 times.

At the beginning of June 2015, a mixed fertilizer of 275 kg/hm² of CaMgP fertilizer, 35 kg/hm² of K₂SO₄ fertilizer and 80 kg/hm² of urea (including 46% of N) were topdressed. In mid-July, the herbage is harvested by mowing, and a stubble height of 7-8 cm was remained. At the beginning of August when the herbage layer was as high as 50 cm, the herbage is harvested again, and a stubble height of 7-8 cm was remained After the herbage was harvested in early August, 30 kg/hm² of Vicia villosa was resown, and 275 kg/hm² of CaMgP fertilizer, 35 kg/hm² of K₂SO₄ fertilizer and 80 kg/hm² of urea (including 46.4% of N) were applied. In mid-November, the regrown herbage was harvested by mowing, and a stubble height of 7-8 cm was remained. From mid-November 2015 to the beginning of May 2016, rotational grazing of sheep was carried out 4 times; the time of the rotational grazing was 5 days each time, and the height of the herbage layer was 3-4 cm after grazing. The management steps from June 2015 to May 2016 was repeated from June 2016 to May 2017.

(5) Comparison of Soil and Herbage Characteristics of Grass-White Clover Grassland Planted by Using the Method of the Present Invention and that Planted by Using a Conventional Planting Method

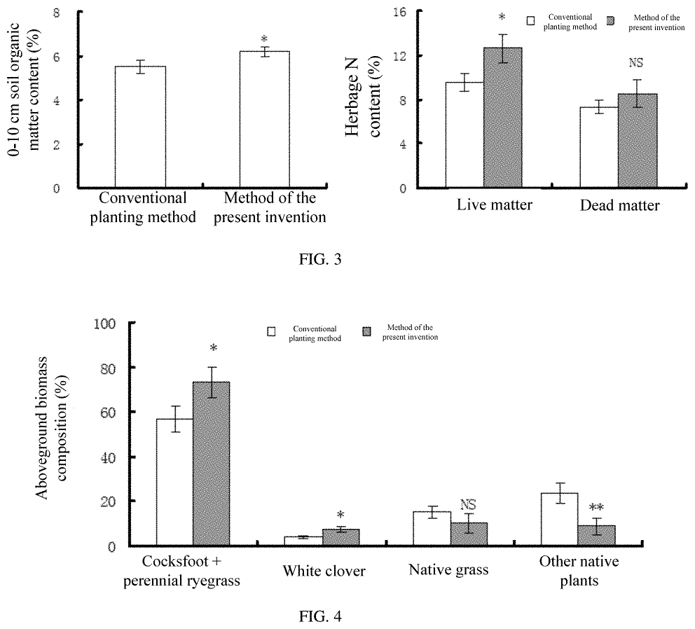

Early August 2017, a 0-10 cm soil organic matter content, aboveground group biomass composition (sown grass (cocksfoot+perennial ryegrasss), white clover, native grass, other native plants) and N contents of aboveground dead and live matters of the grass-white clover grassland planted by using the method of the present invention and that planted by using the conventional planting method (direct plowing and sowing method) were determined, and the results are shown in FIG. 3 and FIG. 4. The results of FIG. 3 show that the soil organic matter content and the N content of the herbage in the grass-white clover grassland planted by using the method of the present invention are higher than those of the conventional planting method; the results of FIG. 4 show that the herbage varieties sown in the grass-white clover grassland planted by using the method of the present invention have a higher aboveground biomass composition than that of the conventional planting method.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A planting method of grass-white clover grassland, comprising the follows steps:
(1) plowing and broadcasting Vicia villosa from July to August in a first year, applying a first base fertilizer, and harvesting the Vicia villosa from December of the first year to March of a second year;
(2) plowing and drilling corn from April to May of the second year, applying a second base fertilizer, weeding in a stage of 5 leaves of the corn, topdressing in a stage of 7-9 true leaves of the corn, and harvesting the corn in September of the second year;
(3) plowing and drilling a grass from September to October of the second year, and applying a third base fertilizer; and
(4) not plowing but broadcasting white clover from May to June of a third year, applying a fourth base fertilizer, and completing the planting.

2. The planting method according to claim 1, wherein in the step (3), the depth of the plowing is 20 cm.

3. The planting method according to claim 1, wherein in the step (3), the grass is perennial ryegrass and cocksfoot; the drilling amount of the perennial ryegrass is 7-8 kg/hm², and the drilling amount of the cocksfoot is 12-18 kg/hm².

4. The planting method according to claim 1, wherein in the step (4), after the broadcasting, the white clover is grazed and trampled by livestock, so that a white clover seed falls into the ground to contact the soil, which is favorable for seed germination.

5. The planting method according to claim 1, wherein the first base fertilizer comprises 225-300 kg/hm² of GaMgP fertilizer, 30-45 kg/hm² of K₂SO₄ fertilizer and 75-90 kg/hm² of urea; the second base fertilizer comprises 225-300 kg/hm² of compound fertilizer; the third base fertilizer comprises 225-300 kg/hm² of GaMgP fertilizer, 30-45 kg/hm² of K₂SO₄ fertilizer and 75-90 kg/hm² of urea; the fourth base fertilizer comprises 225-300 kg/hm² of GaMgP fertilizer, 30-45 kg/hm² of K₂SO₄ fertilizer and 75-90 kg/hm² of urea; in the step (2), the topdressing comprises 400-500 kg/hm² of urea.

6. The planting method according to claim 1, wherein the planting method is applicable for an area in a southern karst region.

7. The planting method according to claim 1, wherein the planting method is applicable for such type of land as grassy hill, grassy slope or seriously degraded grass-white clover grassland.

8. Grass-white clover grassland planted by using the planting method according to claim 1.

9. Grass-white clover grassland planted by using the planting method according to claim 2.

10. Grass-white clover grassland planted by using the planting method according to claim 3.

11. Grass-white clover grassland planted by using the planting method according to claim 4.

12. Grass-white clover grassland planted by using the planting method according to claim 5.

13. Grass-white clover grassland planted by using the planting method according to claim 6.

14. Grass-white clover grassland planted by using the planting method according to claim 7.

15. A management method for the grass-white clover grassland of claim 8, wherein the management method is carried out from a year when planting is completed, and comprises the following steps:
(1) harvesting herbage by mowing from the end of July to the beginning of August, remaining a stubble height of 6-10 cm;
(2) carrying out rotational grazing 2-3 times before November, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;
(3) carrying out rotational grazing 3-5 times from November to May of a second year, wherein the duration of the rotational grazing is 5-7 days each time, and the height of the herbage layer is 2-5 cm after grazing;
(4) topdressing with 225-300 kg/hm² of GaMgP fertilizer, 30-45 kg/hm² of K₂SO₄ fertilizer, and 75-90 kg/hm² of urea in a rainy season from the end of May to the beginning of June of the second year;
(5) harvesting herbage by mowing from June to July of the second year, remaining a stubble height of 6-10 cm;
(6) carrying out rotational grazing 3-4 times before November of the second year, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing; and
(7) carrying out rotational grazing 3-5 times from November of the second year to May of a third year, wherein the duration of the rotational grazing is 5-7 days each time, and the height of the herbage layer is 2-5 cm after grazing; and
repeating the above steps in the order of (4), (5), (6) and (7).

16. A management method for the grass-white clover grassland of claim 9, wherein the management method is carried out from a year when planting is completed, and comprises the following steps:
(1) harvesting herbage by mowing from the end of July to the beginning of August, remaining a stubble height of 6-10 cm;
(2) carrying out rotational grazing 2-3 times before November, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;
(3) carrying out rotational grazing 3-5 times from November to May of a second year, wherein the duration of the rotational grazing is 5-7 days each time, and the height of the herbage layer is 2-5 cm after grazing;
(4) topdressing with 225-300 kg/hm² of GaMgP fertilizer, 30-45 kg/hm² of K₂SO₄ fertilizer, and 75-90 kg/hm² of urea in a rainy season from the end of May to the beginning of June of the second year;
(5) harvesting herbage by mowing from June to July of the second year, remaining a stubble height of 6-10 cm;
(6) carrying out rotational grazing 3-4 times before November of the second year, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing; and
(7) carrying out rotational grazing 3-5 times from November of the second year to May of a third year, wherein the duration of the rotational grazing is 5-7 days each time, and the height of the herbage layer is 2-5 cm after grazing; and
repeating the above steps in the order of (4), (5), (6) and (7).

17. A management method for the grass-white clover grassland of claim 10, wherein the management method is carried out from a year when planting is completed, and comprises the following steps:
(1) harvesting herbage by mowing from the end of July to the beginning of August, remaining a stubble height of 6-10 cm;
(2) carrying out rotational grazing 2-3 times before November, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;
(3) carrying out rotational grazing 3-5 times from November to May of a second year, wherein the duration of the rotational grazing is 5-7 days each time, and the height of the herbage layer is 2-5 cm after grazing;
(4) topdressing with 225-300 kg/hm² of GaMgP fertilizer, 30-45 kg/hm² of K₂SO₄ fertilizer, and 75-90 kg/hm² of urea in a rainy season from the end of May to the beginning of June of the second year;
(5) harvesting herbage by mowing from June to July of the second year, remaining a stubble height of 6-10 cm;
(6) carrying out rotational grazing 3-4 times before November of the second year, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing; and
(7) carrying out rotational grazing 3-5 times from November of the second year to May of a third year, wherein the duration of the rotational grazing is 5-7 days each time, and the height of the herbage layer is 2-5 cm after grazing; and
repeating the above steps in the order of (4), (5), (6) and (7).

18. A management method for the grass-white clover grassland according to claim 8, wherein the management method comprises the following steps:
I. harvesting herbage by mowing from the end of July to the beginning of August, remaining a stubble height of 6-10 cm;
II. carrying out rotational grazing 2-3 times before November, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;
III. carrying out rotational grazing 3-5 times from November to May of a second year, wherein the duration of the rotational grazing is 5-7 days each time, and the height of the herbage layer is 2-5 cm after grazing;
IV. topdressing with 225-300 kg/hm² of GaMgP fertilizer, 30-45 kg/hm² of K₂SO₄ fertilizer, and 75-90 kg/hm² of urea in a rainy season from the end of May to the beginning of June of the second year;
V. harvesting herbage by mowing from June to July of the second year, remaining a stubble height of 6-10 cm;
VI. harvesting herbage by mowing in August of the second year when a herbage layer grows to 40-60 cm in height, remaining a stubble height of 6-10 cm;
VII. resowing Vicia villosa by broadcasting, and topdressing with a first base fertilizer;
VIII. harvesting regrown herbage by mowing in November of the second year, remaining a stubble height of 6-10 cm; and
IX. carrying out rotational grazing 3-5 times from November of the second year to May of a third year, wherein the duration of the rotational grazing is 5-7 days each time, and the height of the herbage layer is 2-5 cm after grazing; and
repeating the above steps in the order of IV, V, VI, VII, VIII and IX.

19. A management method for the grass-white clover grassland of claim 9, wherein the management method comprises the following steps:
I. harvesting herbage by mowing from the end of July to the beginning of August, remaining a stubble height of 6-10 cm;
II. carrying out rotational grazing 2-3 times before November, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;
III. carrying out rotational grazing 3-5 times from November to May of a second year, wherein the duration of the rotational grazing is 5-7 days each time, and the height of the herbage layer is 2-5 cm after grazing;
IV. topdressing with 225-300 kg/hm² of GaMgP fertilizer, 30-45 kg/hm² of K₂SO₄ fertilizer, and 75-90 kg/hm² of urea in a rainy season from the end of May to the beginning of June of the second year;
V. harvesting herbage by mowing from June to July of the second year, remaining a stubble height of 6-10 cm;
VI. harvesting herbage by mowing in August of the second year when a herbage layer grows to 40-60 cm in height, remaining a stubble height of 6-10 cm;
VII. resowing Vicia villosa by broadcasting, and topdressing with a first base fertilizer;
VIII. harvesting regrown herbage by mowing in November of the second year, remaining a stubble height of 6-10 cm; and
IX. carrying out rotational grazing 3-5 times from November of the second year to May of a third year, wherein the duration of the rotational grazing is 5-7 days each time, and the height of the herbage layer is 2-5 cm after grazing; and
repeating the above steps in the order of IV, V, VI, VII, VIII and IX.

20. A management method for the grass-white clover grassland according of claim 10, wherein the management method comprises the following steps:
I. harvesting herbage by mowing from the end of July to the beginning of August, remaining a stubble height of 6-10 cm;
II. carrying out rotational grazing 2-3 times before November, wherein the time of the rotational grazing comes each time when a herbage layer grows to 20-25 cm in height, the duration of the rotational grazing is 7-10 days each time, the intensity of the rotational grazing is 50-60 sheep/hm², and the height of the herbage layer is 4-8 cm after grazing;
III. carrying out rotational grazing 3-5 times from November to May of a second year, wherein the duration of the rotational grazing is 5-7 days each time, and the height of the herbage layer is 2-5 cm after grazing;
IV. topdressing with 225-300 kg/hm² of GaMgP fertilizer, 30-45 kg/hm² of K₂SO₄ fertilizer, and 75-90 kg/hm² of urea in a rainy season from the end of May to the beginning of June of the second year;
V. harvesting herbage by mowing from June to July of the second year, remaining a stubble height of 6-10 cm;
VI. harvesting herbage by mowing in August of the second year when a herbage layer grows to 40-60 cm in height, remaining a stubble height of 6-10 cm;
VII. resowing Vicia villosa by broadcasting, and topdressing with a first base fertilizer;
VIII. harvesting regrown herbage by mowing in November of the second year, remaining a stubble height of 6-10 cm; and
IX. carrying out rotational grazing 3-5 times from November of the second year to May of a third year, wherein the duration of the rotational grazing is 5-7 days each time, and the height of the herbage layer is 2-5 cm after grazing; and
repeating the above steps in the order of IV, V, VI, VII, VIII and IX.
